(19) United States
(12) Patent Application Publication
(10) Pub. No.: US 2008/0172552 A1
(43) Pub. Date: Jul. 17, 2008

(54) Method for the selective and collective transmission of messages in a tmn network

(76) Inventor: Alan Burger, Wienbach (DE)

Correspondence Address: BELL, BOYD & LLOYD, LLP, P.O. BOX 1135, CHICAGO, IL, 60690, US

(21) Appl. No.: 10/472,394

(22) PCT Filed: Jan. 31, 2002
(86) PCT No.: PCT/EP02/01022

§ 371 Date: Sep. 22, 2003

(30) Foreign Application Priority Data
Mar. 22, 2001 (EP) 01107189.1

(51) Int. Cl. G06F 9/00

(52) U.S. Cl. 712/234; 709/251; 709/250

(57) ABSTRACT

The invention relates to a method and to a dvice for the selective and/or time-delayed and collective transmission of messages in a TMN system that is managed according to ITU-T recommendations. To this end, a MassEventDiscriminator is defined as the object class and a MassEventPreprocessor, using the MassEventDiscriminator, transmits only those messages from a network element to an operation system that have an information content significant for the management of the system.

The invention is in the field of network technology based on the TMN architecture (Telecommunication Management Network). Telecommunication Management Network (TMN) is a management concept for innovative telecommunication applications, and is intended to support the usual management requirements. Conceptually, it is a separate network which contains the most diverse interfaces to the network which is to be monitored and controlled. It was developed by a study group of the ITU-T (sector for standardization of the international telecommunication union—ITU—International Telecommunication Network, formerly the CCITT) and is based on the ISO OSI reference model. TMN promotes standardized management of telecommunication networks and the services of every type which are based on them.

The increased need for standardization is accounted for by the growing liberalization of telecommunications, which is characterized particularly by the break up of the telecommunication monopoly. That is why it has become necessary to operate ever more complex networks, and to provide manufacturer-independent management tools which take into account not only new services but also the separation between network operators and service providers.

The TMN consists of various physical elements and their (data-modeling) abstract representations. A network management facility, the so-called operations system, represents the central core, and communicates with network elements, particularly via the interfaces Q₃ to Qₓ.

Network elements are physical units in the network, e.g. a telephone switching system, and can contain several physical devices such as transmission devices (e.g. multiplexers, SDH etc.), line transmission equipment computers, peripherals, etc. A so-called managed object is an abstract representation of the real resource, and comprises solely the management aspects of that real resource. A managed object is described by its attributes, the operations performed on it, the messages sent by it and its relationships with other managed objects.

An object model is an abstract representation of resources managed by the TMN and can, in particular, be defined as a collection of several managed objects.

The invention relates, in particular, to a method for forwarding messages which represent at least one event in the management of operations for a telecommunication network, or in the transmission of units in such a network, the network being administered in accordance with the ITU-T recommendations.

The ITU-T guidelines require that numerous spontaneous reports must be forwarded from a network element to the operations system. These reports are called messages and concern, for example, the formation or deletion of an object, alarms, status changes, changes in the relationships between objects, etc. The messages are defined in the X series of ITU-T guidelines, in particular X.721.

With the methods used until now for network management and based on the ITU-T guidelines, it has therefore been necessary to forward all messages to the operations system.

This can lead to a disadvantageous flood of messages, namely if an event which causes a message triggers a flood of further events, which in turn entail the issuing of messages.

This method proves to be disadvantageous for several reasons. On the one hand, the network and/or the communication channel can be overloaded. On the other hand, it is more difficult to filter out from the host of messages those which are relevant for solving the actual problem, namely to restore the system to its normal operational state after a fault incident.

The object of the present invention is therefore to provide a method, a network management system and a device which will forward to the operations system in a network, in particular a TMN network, only those messages which provide additional information, and to summarize the other messages and forward them at a later point in time as a packet, without the need for developing a new system concept.

This object is achieved in accordance with the invention by the method mentioned above, in particular by a method for forwarding at least one message which represents at least one event in the context of the operational management of a telecommunication network, the method comprising the following steps:
define the message,
acquire the data relating to the message and/or the associated event,
categorize the message on the basis of the data acquired into at least one of the two classes ‘non-causative’ and ‘causative’,
store the message and forward it selectively, in that the message is forwarded directly or immediately if it has been categorized into the ‘causative’ class, and in that otherwise:

the message is forwarded at a later point in time and, in particular, collectively together with other messages.

A significant advantage which can be seen in the method in accordance with the invention is that the traffic load in the system can be reduced.

Furthermore, it is possible to classify events with respect to their importance for the restoration of the system to its normal operational state. Less important messages and/or their processing can then be postponed in order to give preference to and process the relevant messages. The response or speed of the system is thereby increased.

When the object of the invention is achieved in accordance with claim 15 and 16, a network management system and an appropriate device are provided, which are designed for forwarding at least one message from a network element to at least one operations system, where the message represents at least one event in the management of the operations of a telecommunications network which is managed in accordance with the ITU-T guidelines, with:
one object class which is used as the classification unit and which specifies whether the message can be categorized into a class of ‘causative’ or into a class of ‘non-causative’, and
one forwarding mechanism which is topologically between the network element and the operations system and which forwards the message to the operations system selectively, and only immediately if the message or the event which initiated it has been categorized in the class ‘causative’.

The preferred form of embodiment of the inventions comprises two components:
an object class which is included in an object model and which specifies at an abstract level the class or category into which the event falls, and
a software component which forwards all the messages to the operations system, in ways which differ depending on their classification.

A first possible form of this forwarding is the immediate and individual forwarding of messages to the operations system. A second form consists in the collecting together of several messages which do not need to be communicated immediately, and forwarding them together at a later point in time. In this case, the point in time at which the collected message communication is issued can either be a variable or can be at predefined cyclic intervals.

The invention is based on the following subdivision or classification of events into two categories:

1. the category “causative”, and

2. the category “non-causative”.

Here, the first category “causative” is defined by the events or by the messages which they have invoked, which automatically initiate further events within the network.

All other events or messages are classified in the second category as “non-causative”.

In the preferred embodiment of the invention, the second category is yet further specified, namely by such events as are on the one hand not causative and are additionally ‘caused’, i.e. have arisen as a result of a previous causative event. The class ‘caused’ is a sub-class of the class ‘not causative’.

It is advantageous if all the messages, whether forwarded immediately or after a delay, are saved in a database log file. This will allow new messages to be compared with the saved messages, to determine whether a message already received is the cause of a message which is currently to be processed. If yes, then the message is a caused message, i.e. a message which has been caused by an earlier message or an event which that message represents. In this case the message can be saved—preferably as an instance of the object class ‘caused’—for later forwarding collectively with other messages. In accordance with the invention, the immediate forwarding of this message will be suppressed, because it has only arisen as a causal consequence of a previous event which has already been reported, and therefore it supplies no new information for the restoration the system.

In accordance with the invention, the only messages which will be forwarded individually to the operations system with no time delay are the causative ones which have an influence on subsequent events within the network, and thus entail consequential events.

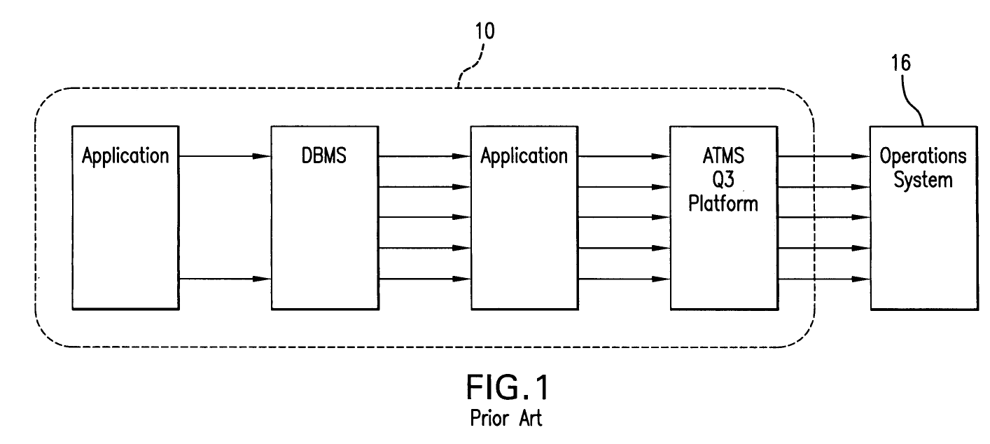

An example of the flood of messages which—according to the main idea underlying the invention—do not all have to be forwarded immediately (because they are not causative) can be described by means of the characteristic of containment and with reference to FIG. 1:

containment makes the existence of a managed object dependent on the existence of another managed object, that is to say the existence of the contained object depends on the existence of the containing object (e.g. a certain bandwidth can only be present if a transmission channel exists). An error in the containing object automatically has an effect on the contained object. In this case, the management application will request that an error in a containing object be reported to the operations system, via several intermediate stations (database management system, application, Q3 platform), as shown in FIG. 1. With the method used until now in accordance with the prior art, it will in addition request for each individual contained object an appropriate message to the operations system via the various intermediate stations.

Thus, from what was originally two messages numerous messages arise within the network, and numerous messages to the operations system.

Equally, certain relationships between the objects can result in the generation of non-causative events, the messages for which can be suppressed in accordance with the invention until a certain point in time. For example, if a mutual relationship exists between two objects, so that each of these managed objects includes a reference to the other, then when one of the objects is deleted it is essential that all the references to this object are also deleted in order to guarantee the integrity of the referencing. The deletion of the references generates in turn additional (caused) messages, but these represent no additional information for the operations system, and can thus be forwarded after a delay and collectively with other messages.

The invention therefore provides for each message to be analyzed before it is forwarded to the operations system, in order to investigate whether or not it is a causative message, that is a message which has arisen as a result of a causative event, or is a non-causative message, that is a message, or an event which it represents, which does not automatically trigger any further events. In the latter case, the immediate communication of the message can be suppressed.

It is preferable that independent investigations are made into whether the message is a causative message and whether it is a caused message. This allows the method in accordance with the invention to cover also the cases in which a message can be classified simultaneously into both categories (caused—causative). In such a case, the message will be forwarded because, in accordance with the invention, the instance ‘causative’ is processed first and has a higher priority than the instance ‘caused’.

Additional advantageous forms of embodiment arise from the subclaims. The prior art method used until now, further advantages of the invention and particular embodiments with their characteristics, are presented below in the detailed description of the figures.

These figures show:

FIG. 1 a schematic representation of messages in a prior art system,

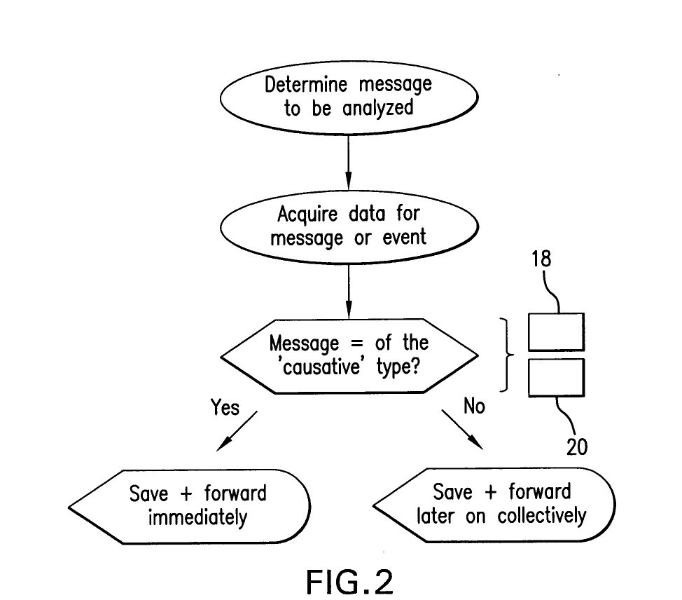

FIG. 2 a flow chart for one embodiment of the present invention.

In what follows below, the fundamental sequence of activities in the method according to the invention is presented briefly by way of an introduction, and then—by reference to FIG. 2—the sequence of activities is described with reference to one preferred form of embodiment.

A network system, which is managed in accordance with the ITU-T principles, consists of network elements 10 which are represented abstractly in the data model as managed objects 12 or objects 12, as appropriate. During the operation of the network, network element 10 sends messages 14, which represent events, to an operations system 16, to enable the network system to be managed optimally.

In the preferred embodiment, the network is an ATM network, which is managed in accordance with the principles of the TMN. The additional components in accordance with the invention are embedded in the existing TMN architecture and make possible a gain in functionality in respect of the transmission of the messages 14 which represent certain events in the system. The forwarding of selected messages 14 can be suppressed, so that they can then be passed on at a later point in time and together with other messages 14. This brings the advantage that the system cannot be overloaded with the processing of messages 14 which supply no additional information for the maintenance of the operation of the network system.

A further advantage lies in the fact that bandwidths are not unnecessarily occupied in connection with the transmission of data, as is the case for prior art methods.

For the selective forwarding of messages 14, the invention makes use of two main components:
a MassEventDiscriminator 18, and
a MassEventPreprocessor 20.

The MassEventDiscriminator 18 is an object model in the TMN architecture, and comprises an object class which specifies at the data modeling level whether an event falls into one of two categories. These categories are:

1. ‘causative’, namely in cases when the event automatically causes at least one further event or consequential event, and

2 ‘non-causative’, and in the preferred form of embodiment of the invention this class or category is restricted to such so-called ‘caused’ events as arise as a result of a preceding causative event. This class is called ‘caused’. From a set-theoretical point of view, the class ‘caused’ is a sub-set of the class ‘non-causative’.

The MassEventPreprocessor 20 is designed as a software component, and has an interface to the network element 10 and the operations system 16. Functionally, in respect of the forwarding of messages 14, the MassEventPreprocessor 20 is topologically between the network element 10 and the operations system 16. It analyzes the event to be investigated, to determine which type it is (causative or caused—see above), and depending on this classification it initiates different method steps for transmitting the message 14 concerned. The behavior of the MassEventProcessor 20 is controlled by the data, in particular by the MassEventData. The MassEventProcessor 20 is, so to speak, based on the MassEventDiscriminator 18.

As shown in FIG. 2, if the event was of the type ‘causative’ the message 14 is saved and forwarded immediately and individually (as before) to the operations system 16. Otherwise, that is for an event of the type ‘caused’, the message is saved as an instance of the object class ‘caused’, and is later transmitted collectively together with other messages 14. That is, the immediate issuing of the message 14 concerned (which provides no new information for the operations system 16) is suppressed in accordance with the invention.

In a very advantageous alternative embodiment of the invention, that part of the method which is responsible for checking whether the event is a causative one or not (this is indicated in FIG. 2 by the components 18 and 20) is a part of the Q3 API.

The invention is fundamentally based on three object classes for the modeling of the data at an abstract level, namely:

1. the MassEventDiscriminator 18,

2. the class ‘causative’, in particular a ‘causalEvent’, and

3. the class ‘caused’, in particular an ‘effectEvent’.

The instances of the first class will preferably be stored in semi-permanent form in the database management system, because these data items are only rarely changed. On the other hand, the instances of the two other object classes are more short-lived. However, even if this data is lost, the method in accordance with the invention will function advantageously and without problem, in that more messages 14 will be forwarded.

It is advantageous that the solution in accordance with the invention can resolve the problems resulting from the superfluous transmissions of messages 14 without the need for changes to the ITU-T standards. As a result, the present method can be applied to all existing and future TMN architectures.

1. A method for forwarding messages as defined by ITU-T Guidelines X.721, which represents at least one event in the operational management of a telecommunication network, comprising:
determining at least one of the message;
acquiring data relating to at least one of the message and an associated event;
categorizing the message on the basis of the data acquired into at least one of non-causative and causative classes; and
storing the message and forwarding the message selectively, wherein the message is forwarded immediately if it has been categorized into the causative class, and in that otherwise the message is forwarded at a later point in time.

2. The method in accordance with claim 1,
wherein the selective forwarding of the message is effected automatically.

3. (canceled)

4. The method in accordance with at claim 1,
wherein the method is executed on a Q3 platform.

5. The method in accordance with claim 1,
wherein for the event which is represented by the message, the data covers at least all the predecessor events which cause the event and successor events caused by the event.

6. The method in accordance with claim 1,
wherein the data is acquired, by executing at least one query on a database, to determine in particular whether the event may have been stored as a causative event.

7. The method in accordance with claim 1,
wherein the event corresponding to the message is categorized into the causative class if the event includes at least one other event or has a relationship with at least one other event.

8. The method in accordance with claim 1,
wherein the event corresponding to the message is categorized into the non-causative class if the event was a consequence of at least one preceding causative event.

9. The method in accordance with claim 1,
wherein a unique event identifier is assigned to each event, and is saved together with other event-specific parameters in a database.

10. The method in accordance with claim 1,
wherein a log is kept of the method with its results, in particular with the classification of the event into either the causative and non-causative classes.

11. The method in accordance with claim 1,
wherein the point in time at which the collected messages are forwarded is time-dependent and, in particular, is at least one of in cyclic intervals and can be set dynamically.

12. The method in accordance with claim 1,
wherein the selective forwarding of the message is effected to recipients who are at least one of automatically selected and to be determined.

13. A method of using at messages as defined by ITU-T guidelines X.721, which represents at least one event in the operational management of a telecommunication network, comprising:
determining the message;
acquiring data relating to at least one message and an associated event;
categorizing the at message on the basis of the data acquired into at least one of non-causative and causative classes;
storing the message and forwarding the message selectively, wherein the message is forwarded immediately if it has been categorized into the causative class, and in that otherwise the message is forwarded at a later point in time
wherein selected messages are collected together and forwarded as a bundle at a later point in time.

14. Use of the method in accordance with claim 1, wherein the method is integrated into a TMN management system.

15. A Network management system designed to forward messages defined by ITU-T guidelines X.721, which represents at least one event in the operational management of a telecommunication network, and including determining the message, acquiring data relating to at least one message and an associated event, categorizing the at message on the basis of the data acquired into at least one of non-causative and causative classes, storing the message and forwarding the message selectively, wherein the message is forwarded immediately if it has been categorized into the causative class, and in that otherwise the message is forwarded at a later point in time, comprising:
a classification unit which adapted to categorize the message into the causative class or into the non-causative class; and
a forwarding mechanism which is connected between a network element and network management facility and adapted to forwards the message to the network management facility, and only immediately if the message or the event which initiated it has been categorized in the causative class.

16. A netowrk management device designed for forwarding at least one message from a network element to at least one operations system, where the message represents at least one event in the operational management of a telecommunication network which is managed in accordance with the ITU-T guidelines, comprising:
a classification unit which is adapted to categorize the message into a causative class-or into a non-causative class; and
a forwarding mechanism which is connected between a network element and network management facility and adapted to forwards the message to the network management facility, and only immediately if the message or the event which initiated it has been categorized in the causative class.
